(19) United States
(12) Patent Application Publication
(10) Pub. No.: US 2016/0307165 A1
(43) Pub. Date: Oct. 20, 2016

(54) Authorizing Participant Access To A Meeting Resource

(71) Applicant: Cisco Technology, Inc., San Jose, CA (US)

(72) Inventors: Nicolai Grødum, Oslo (NO); Magnus Aaen Holst, Kjeller (NO)

(21) Appl. No.: 14/690,884

(22) Filed: Apr. 20, 2015

(51) Int. Cl. G06Q 10/10; G07C 9/00; H04N 7/15; H04L 12/18

(52) U.S. Cl. CPC G06Q 10/1095; H04L 12/1822; G07C 9/00015; H04N 7/15

(57) ABSTRACT

For a meeting resource having a publicly known or readily ascertainable address or name and that is associated with a meeting resource owner, a unique meeting key is generated for a particular meeting that is scheduled to occur using the meeting resource. The unique meeting key allows a participant to have access to the meeting resource only after the meeting resource owner has accessed the meeting resource with the same unique meeting key.

### TECHNICAL FIELD

The present disclosure relates to managing access to meeting resources.

### BACKGROUND

Restricting users from joining or using a meeting resource (e.g. a publicly known virtual meeting room (CMR) or a physical meeting room) is currently done by locking down outside access and manually removing participants from accessing the resource. Other meeting resources are often restricted by distributing a pin or a password with the meeting invitation.

### BRIEF DESCRIPTION OF THE DRAWINGS

FIG. 1 is a diagram illustrating a system in which meeting participants can access a meeting resource (virtual or physical) under controlled conditions set by the meeting resource owner, according to an example embodiment.

FIG. 2 is a diagram generally depicting how a meeting key is generated for a meeting resource, according to an example embodiment.

FIG. 3 is a block diagram of a user device and a server configured to support the controlled access to a meeting resource, according to an example embodiment.

FIG. 4A is a sequence diagram illustrating operations performed to generate a unique meeting key for use in accessing a meeting resource, according to an example embodiment.

FIG. 4B is a sequence diagram illustrating operations to generate a unique meeting key according to another example embodiment.

FIG. 5 is a sequence diagram illustrating in more detail operations to determine whether to permit a user to access a personal meeting room, according to an example embodiment.

FIG. 6 is a high-level flow chart of a method to generate a unique meeting key for accessing a meeting resource, according to an example embodiment.

FIG. 7 is a high-level flow chart of a method to determine whether to allow a user to access a meeting resource, according to an example embodiment.

### DESCRIPTION OF EXAMPLE EMBODIMENTS

### Overview

In accordance with one embodiment, for a meeting resource having a publicly known or readily ascertainable address or name and that is associated with a meeting resource owner, a unique meeting key is generated for a particular meeting that is scheduled to occur using the meeting resource. The unique meeting key allows a participant to have access to the meeting resource only after the meeting resource owner has accessed the meeting resource with the same unique meeting key. The unique meeting key is distributed to one or more participants for the particular meeting that is scheduled to occur using the meeting resource.

In accordance with another embodiment, a unique meeting key is received from a participant for a particular meeting scheduled to use a meeting resource having a publicly known or readily ascertainable address or name and that is associated with a meeting resource owner. It is determined whether the meeting resource owner has already accessed the meeting resource with the same unique meeting key for the particular meeting. If it is determined that the meeting resource owner has already accessed the meeting resource with the same unique meeting key, the participant is permitted to access the meeting resource.

### Example Embodiments

Presented herein are embodiments that control when and if users (participants) can access into a private/personal meeting resource. The personal meeting resource may be a physical meeting room, or a virtual meeting room, such as a virtual personal meeting room supported by a web-based meeting service, or any type of meeting equipment (e.g., a video conference endpoint). In other words, separate meetings are scheduled for use of the personal meeting resource and a unique meeting key is generated for each meeting that is to occur with the personal meeting resource.

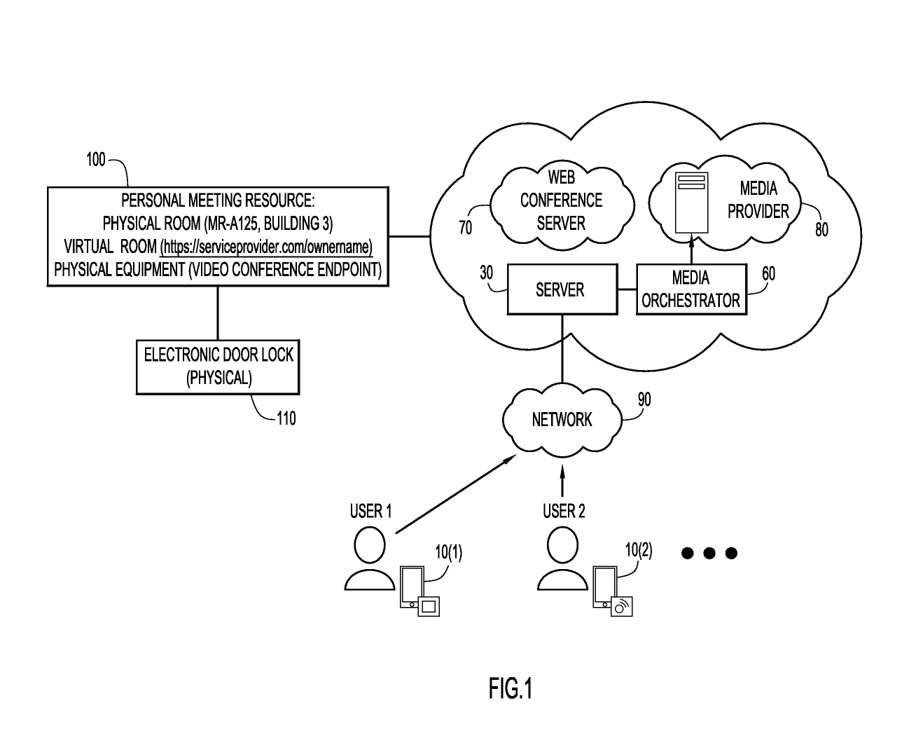

Referring first to FIG. 1, a diagram is shown of a network environment in which the apparatus, system, and methods presented herein may be deployed. FIG. 1 shows an example in which there are multiple user devices, e.g., user devices 10(1) and 10(2) each running a calendar application of some type. The calendar application may be a stand-alone function on a user device or may be integrated into, or interfaced with, another application, such as a web conference application. The user devices can take on a variety of forms, including a SmartPhone, tablet, laptop computer, desktop computer, video conference endpoint etc. The user devices 10(1) and 10(2) communicate with a server 30.

FIG. 1 shows that there is a media orchestrator function 60, web conference server 70 and media provider 80 that may reside in a cloud or data center computing environment. The media orchestrator 60 ensures that all the participants get connected to the same meeting being supported by the media provider 80, or in the case of multiple media providers, to the appropriate one or more media providers. The functions of the media orchestrator 60 and/or the media provider(s) 80 may be performed by separate entities as shown, or may be integrated into the functions performed by the server 30 (either on-premises, in the cloud, or a hybrid of on-premises and cloud). The user devices 10(1) and 10(2) communicate with server 30 via a network 90. Network 90 may be any one or more of a wired or wireless local area network (LAN) and wired or wireless wide area network. The network 90 may support a variety of protocols, including without limitations, Session Initiation Protocol (SIP), Hypertext Transfer Protocol (HTTP), Real-time Transport Protocol (RTP), etc.

As further shown in FIG. 1, there is a personal meeting room 100. As explained above, the personal meeting resource 100 may be a physical meeting room in an office building, a virtual personal meeting room supported by a web-based or online meeting service, e.g., the web conference server 70, or a physical piece of equipment (e.g., a video conference endpoint). If the personal meeting resource 100 is a physical meeting room (e.g., named MR-A125, Building 3 as an example), it may further include an electronic door lock 110 that controls access to the personal meeting room 100. For example, in some business environments, a physical meeting room may be assigned one or more “owners” who are people that have exclusive control to use of the meeting room. On the other hand, the personal meeting resource 100 may be a virtual meeting room (having an associated Universal Resource Locator (URL), e.g., https://serviceprovider.com/ownername), where “ownername” may be the name of the meeting room owner. Further still, the personal meeting resource may be equipment (e.g., video conference endpoint) that has password protection capabilities to prevent unauthorized access or use.

It is to be understood that the personal meeting resource 100 shown in FIG. 1, if it is a physical meeting room or physical equipment, will have network connectivity, and in particular, network connectivity is enabled to the electronic door lock 110. On the other hand, if the personal meeting room 100 is a virtual meeting room, then it is to be understood that it actually is fictional creation, represented by data, by a service, such as the server 30 or the web conference server 70.

Generally, a virtual personal meeting room having an easily guessable or readily ascertainable link can be entered by anybody at any time if they knew the name/link for the meeting room. Someone who is not invited to a meeting in the meeting room could enter the meeting or eavesdrop in a meeting being held in the meeting room.

It is useful to be able to prevent users from joining or using a personal meeting resource unless the owner of that meeting resource is present and is attending the same scheduled meeting. The meeting can be scheduled using any calendar system capable of connecting invitees with a common meeting identifier. In other words, even though the personal meeting room/resource may be allocated to a meeting room owner, it is still advantageous to be able to schedule individual meetings using the personal meeting resource, and allow the personal meeting resource owner control who may access the personal meeting resource for each individual meeting.

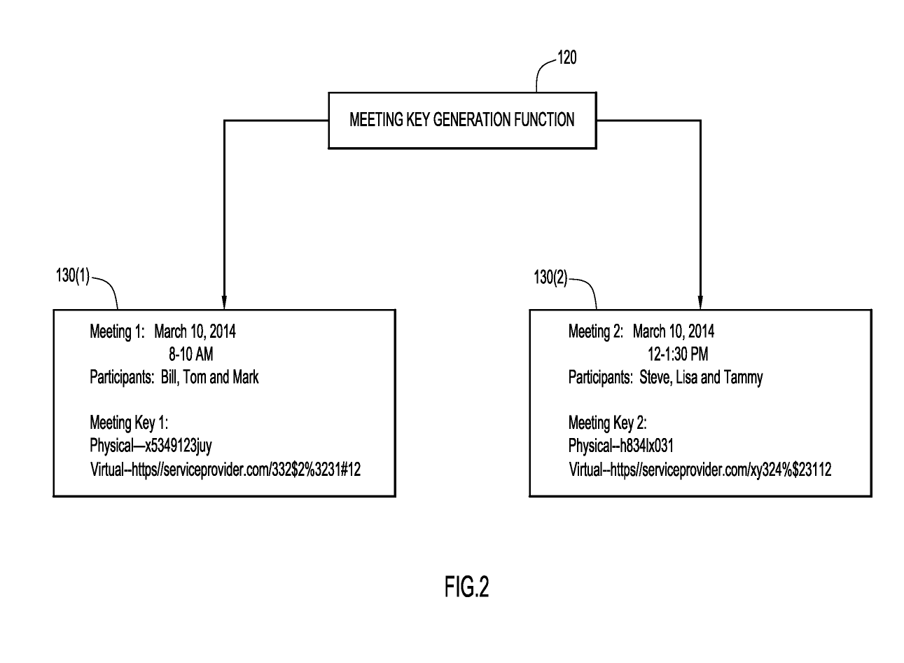

According to the embodiments presented herein, a unique meeting key is generated for each individual meeting to be conducted with the personal meeting resource. Reference is now made to FIG. 2. FIG. 2 shows that there is a meeting key generation function 120. The meeting key generation function 120 generates a unique meeting key for each meeting to be conducted in the personal meeting room. As described further hereinafter, the meeting key generation function 120 may reside locally on a client function running on a user device or remotely on the server 30.

The unique meeting key can take on a variety forms. If the personal meeting resource is a physical meeting room, then the unique meeting key may be a numeric or alphanumeric code to an electronic lock on a door to the physical meeting room. For example, as shown in FIG. 2, for Meeting 1 (8-10 AM on Mar. 10, 2014), the unique meeting key for a physical personal meeting room is x5349123juy. For Meeting 2 (12-1:30 PM on Mar. 10, 2014), the unique meeting key for a physical personal meeting room is h8341x031. If the personal meeting room is a virtual meeting room, then for Meeting 1, the unique meeting key may be https//serviceprovider.com/332$2%3231#12, and for Meeting 2, the unique meeting key may be https//serviceprovider.com/xy324%$23112. If a user can present a unique meeting key to enter a personal meeting resource, he/she is assumed to have been invited.

As explained further hereinafter, the unique meeting key may be based on meeting identifier generated by a calendar application or similar function, or the unique meeting key may be based on a random selection of characters (numbers and/or letters). As shown in FIG. 2, when the personal meeting room is a virtual meeting room for a web-based meeting, the unique meeting key is, or is contained in, a link to a web-based meeting hosting service for the virtual personal meeting room or to a proxy service for the web-based meeting hosting service. The unique meeting key may include the publicly known or readily ascertainable address or name of the meeting room, in addition to a unique string of characters. For example, if the link to the virtual personal meeting room is https://serviceprovider.com/username, then the unique meeting key may be https://serviceprovider.com/username/340d213%7tx, where 340d213%7tx is the unique part of the link that serves to uniquely identify a particular meeting in the virtual meeting room, and is different for each meeting scheduled in the virtual personal meeting room. Moreover, the unique meeting key may be configured to be displayed as a link containing the publicly known or readily ascertainable address or name and having associated therewith, and not displayed, a unique string of characters. For example, to a user, the link may appear as https://serviceprovider.com/username, but when the user clicks on this link, there are additional characters that are part of the link that distinguish it as a unique meeting key.

For a virtual personal meeting room, the unique meeting key may be, or may be contained in a Uniform Resource Identifier (URI) of any URI scheme, such as a URI with a scheme for the Session Initiation Protocol (SIP) or a URI with a scheme for the Hypertext Transport Protocol (HTTP), or Hypertext Transport Protocol Secure (HTTPS).

The key can be presented by a “referred-from” attribute in the protocol in use. This is already a part of SIP and HTTP(S) and can be put into the request by a proxy service. The proxy could get the data in any number of ways, the simplest being signaled directly from the client or contained in the URI. Alternatively, the unique meeting key can be part of the URI without using a proxy, as described above.

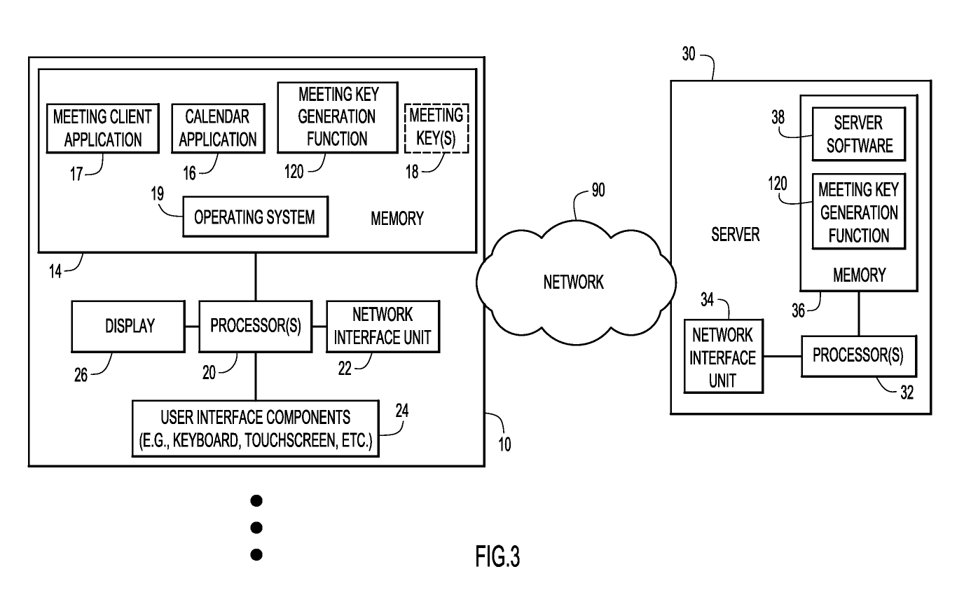

Reference is now made to FIG. 3. FIG. 3 shows a block diagram of a user device 10 having a meeting key generation function 120, and server 30 that may also have the meeting key generation function 120. The user device 10 and server 30 are in communication with each other via network 90.

The user device 10 may include a memory 14 storing the software instructions for the meeting key generation function 120, along with software instructions for a calendar application 16, a meeting client application 17 (e.g., web conference client application, endpoint client application, etc., that uses, interfaces or has integrated therein functions of the calendar application), and one or more meeting keys 18 generated by the meeting key generation function 120. For the sake of completeness, FIG. 3 also shows an operating system 19 on which the application 16 and the meeting key generation function 120 run. The user device 10 further includes a processor 20 (e.g., a microprocessor or microcontroller), a network interface unit 22 that enables wired and/or wireless network communication, one or more user interface components 24 (e.g., keyboard, mouse, touchscreen, etc.) and a display screen/monitor 26. Other user devices may have a similar block diagram representation as that shown for user device 10 shown in FIG. 3.

The server 30 includes one or more processors 32, a network interface unit 34 and a memory 36. The memory 36 stores instructions for server software 38 and optionally, instructions for the meeting key generation function 120.

The memory 14 and memory 36 shown in FIG. 3 may include read only memory (ROM), random access memory (RAM), magnetic disk storage media devices, optical storage media devices, flash memory devices, electrical, optical, or other physical/tangible memory storage devices. Thus, in general, the memory shown in FIG. 3 may include one or more tangible (non-transitory) computer readable storage media (e.g., a memory device) encoded with software comprising computer executable instructions and when the software is executed (by the associated processor) the processor is operable or caused to perform the operations described hereinafter.

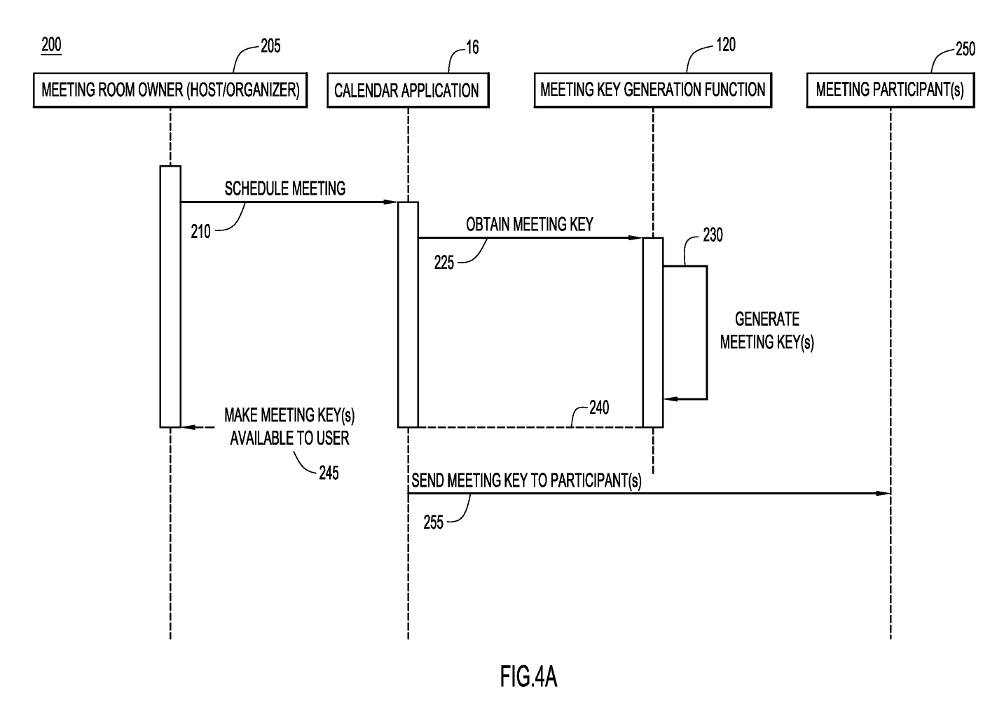

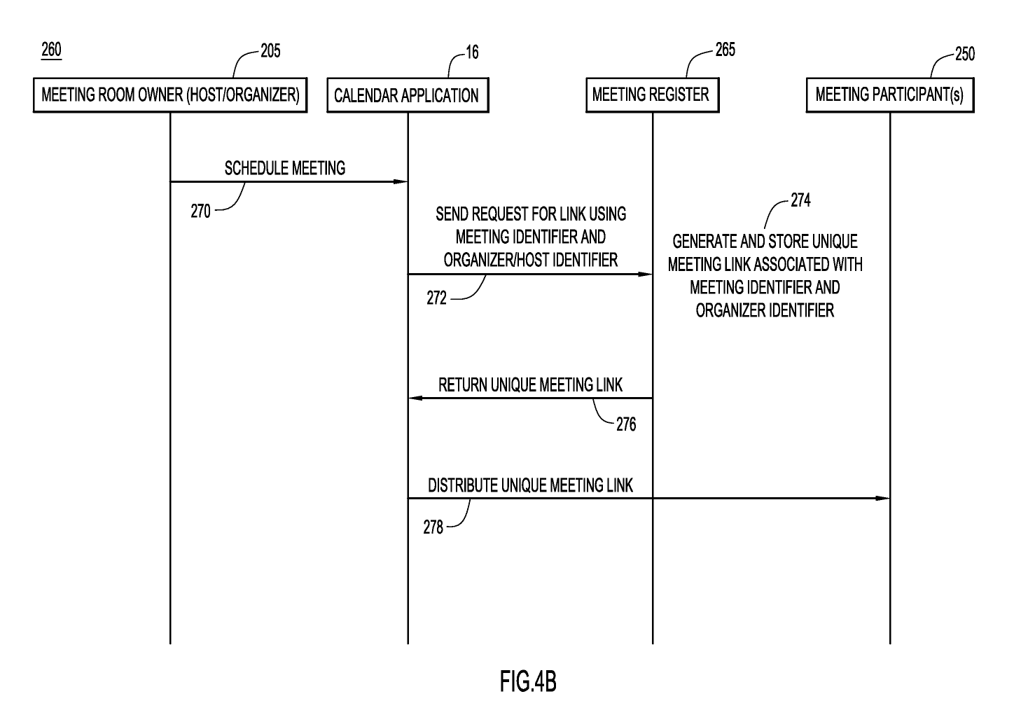

Reference is now made to FIG. 4A, which illustrates a flow for the process 200 of generating a meeting join link. The process 200 involves application of the meeting key generation function 120 for a meeting room owner or someone authorized to act on behalf of the meeting room owner or host 205, or for any person that has received an invitation to a meeting in the personal meeting room of the meeting room owner but does not yet have a unique meeting key for that meeting. At 210, any user of a user device can initiate the process 200 by making a user interface request to schedule a meeting to be held in his/her personal meeting room. At 225, the calendar application 16 sends a request to the meeting key generation function 120. At 230, the meeting key generation function 120 generates a unique meeting key of any of the forms described above. In one example, the meeting key generation function is generated based on a meeting identifier generated by the calendar application 16. Since every meeting identifier is unique, the meeting key for a meeting will be unique, even though it could be one of several meetings scheduled to be conducted in the personal meeting room. At 240, the meeting key generation function 120 returns the unique meeting key to the application which stores it in memory and can make it available to the meeting room owner at 245. Thereafter, the meeting room owner may make the meeting key available to one or more invited meeting participants 250 of a particular meeting, such as by sending a meeting invitation using the calendar application 16, as shown at reference numeral 255.

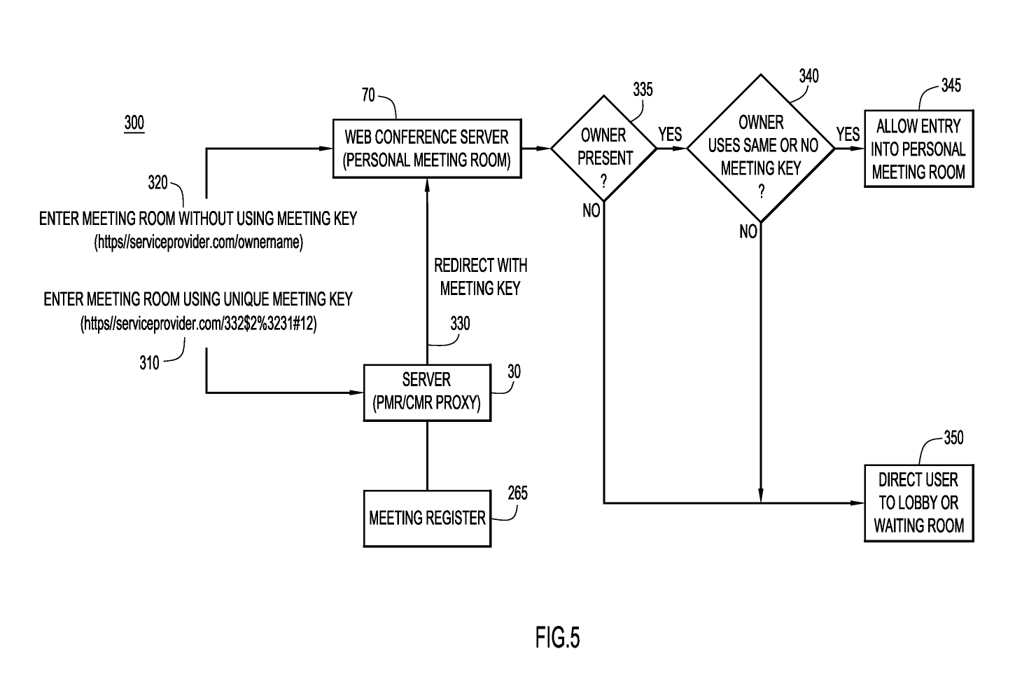

Thus, FIG. 4A, the host makes up (using client side algorithm or selected/created by host) a unique meeting key and forwards it to the invitees of a specific meeting. As the invitees enter the meeting room, they enter the meeting key they were given, as described hereinafter in connection with FIG. 5.

The meeting identifier may be any identifier that is unique to the scheduled meeting. In one example, the calendar (or other similar) application that is used to schedule a meeting generates the meeting identifier that is compliant with the Internet Calendaring and Scheduling Core Object Specification (iCalendar) of RFC 5545, or any other suitable format that is common or compatible with applications running across user devices.

The iCalendar (iCal) object generated for a meeting includes a universal identifier (UID), and this UID may be used as the meeting calendar identifier. An example format of an iCalendar object is provided in RFC 5545, and example format of the UID is: 19970610T172345Z-AF23B2@example.com.

As explained above, any user device with the meeting key generation function can generate a meeting key for a scheduled meeting in a personal meeting room. For example, the meeting key may be generated at the time the meeting is scheduled, or it can be generated at any time after the meeting has been scheduled. However, the meeting key needs to be generated and sent to a user participant before he/she can join the meeting because the unique meeting key is used to connect to the server 30 (FIGS. 1 and 2) in order for the server to identify the meeting and allow the user to enter into the personal meeting room.

Reference is now made to FIG. 4B for description of a process 260 for obtaining a unique meeting key in the form of a unique meeting link for use in entering the meeting room owner's personal meeting. The process 260 involves the use of a meeting register 265, which is a separate server or a function of server 30 (or a function of the web conference server 70 shown in FIG. 1) that is used to generate and store unique meeting links in association with particular meetings to be held in a meeting room owner's personal meeting room. At 270, the meeting room owner (host/organizer) sends a request to the calendar application 16 running on his/her device. At 272, the calendar application 16 sends to the meeting register 265 a request for a unique meeting link. The request may include a meeting identifier (generated by the calendar application 16) and an organizer identifier (e.g., the organizer identifier is the email address of, or is derived from, the email address of the host/organizer). At 274, the meeting register 265 generates a unique meeting link (of any of the forms described herein) and stores information that associates the unique meeting link with the meeting identifier and organizer identifier. In so doing, the meeting register 265 thereby stores information associated a particular unique meeting link with a particular meeting to be held in the meeting organizer's personal meeting room. Thus, the meeting register 265 knows to which personal meeting room to direct a participant when the participant uses a particular unique meeting link, as described hereinafter. At 276, the meeting register 265 returns the unique meeting link to the calendar application 16. Thereafter, the unique meeting link may be distributed by the calendar application 16 (e.g., via an email calendar invitation) to the one or more meeting participants 250. As described further below in connection with FIG. 5, any participant connecting to the server 30 with this link, with the meeting identifier attached, will be forwarded to the web conference server 70 to use in admitting the participant to the personal meeting room.

As a variation to process 260, any client application running on a user device can request a unique meeting link from the meeting register 265, by sending a request containing a meeting identifier and organizer identifier (to thereby identify the personal meeting room). The unique meeting link can thereafter be distributed by any scheduling platform or tool, as described above. Any participant connecting to the server 30 (proxy) with this link will be forwarded to the web conference server 70, with the meeting identifier attached for use in determining whether to admit the participant to the personal meeting room of the meeting organizer/host.

As explained above, the meeting key may be incorporated in a link of any type of link, e.g., SIP link, web conference (e.g., WebEx link), etc. It is a dial string for a given technology domain. Once generated, the link is saved in memory on the user device where it is generated. That is, it is presented to a user as a clickable link or dial string that, when clicked, establishes a connection to the server 30.

To reiterate, the unique meeting key for a virtual meeting room may take any of a variety of forms, and also may include the publicly known or readily ascertainable link or name for the persona meeting room, plus some additional “salt or secret” collection of characters (alphanumeric and other characters) to make the unique meeting key extremely difficult to guess. The additional collection of characters that make the otherwise publicly known or readily ascertainable link or name unique may be behind a hash tag. The unique meeting key may be randomly generated each time a meeting is scheduled in the personal meeting room. The entire link that includes the meeting key could be fully human-readable, albeit non-guessable.

Still another possibility is one that does not involve distributing a unique meeting link. Anyone can call/connect with a client application using a meeting identifier and organizer identifier to a service provider to request a dial number or meeting link for a particular meeting (specified by a meeting identifier) in a particular personal meeting room (indicated by the organizer identifier). The request may be denoted as <client_side_function(organizer identifier and meeting identifier)>@serviceprovider.com (or HTTP(S) equivalent). The server 30 (proxy) will send an inquiry to the meeting register 265 and the meeting register 265 will create the meeting link as needed (based on meeting identifier and organizer identifier). The user will then be forwarded to the web conference server 70, with the meeting identifier attached.

Reference is now made to FIG. 5 for a description of a process 300 by which a participant attempts to enter a personal meeting room. Generally, there are two ways that a participant can enter a personal meeting room: using a unique meeting key for a particular meeting in the personal meeting room as shown at 310 or without use of a unique meeting key for a particular meeting, as shown at 320. If a participant attempts to enter a personal meeting room using a unique meeting key, the link containing that meeting key will direct the participant to the server 30, as described above.

The server 30 (labeled Custom Meeting Room/Personal Meeting Room (CMR/PMR) Proxy) will examine the link used to access the personal meeting room (which will contain a unique meeting key), and at 330, redirect the participant to the web conference server 70 which hosts the personal meeting room. More specifically, the server 30 (acting as a proxy) can either forward the lookup (where a meeting identifier and organizer identifier is associated with a particular personal meeting room address) to the meeting register 265, or looks up in its own for policies associated with a meeting organizer identifier (e.g., e-mail address). The server 30 forwards the request to personal meting room supported by the web conference server 70, adding a “redirected from” value containing the unique meeting key.

At 330, the server 30 redirects the participant to the web conference server 70 that hosts the personal meeting room, together with the meeting key. At 335, the web conference server 70 determines whether the meeting room owner has already entered the meeting room. In other words, the flow from 310 and 330 to the conference server 70 via the server 30 will also be performed for the meeting room owner when he/she attempts to enter his/her personal meeting room. If at 335, it is determined that the meeting room owner is present in the personal meeting room, then at 340, it is determined whether the meeting room owner has entered the personal meeting room using the same unique meeting key (as used by the participant) or with no meeting key. If the meeting room owner had entered the personal meeting room using the same unique meeting key as a participant has now used to enter the personal meeting room, then the participant is allowed entry into the personal meeting room as shown at 345. However, if it is determined that the meeting room owner had entered the personal meeting room with a different meeting key or without use of meeting key, then the participant is directed to a virtual lobby or virtual waiting room as shown at reference numeral 350. Operations 335, 340, 345 and 350 may be performed by an authorization engine/process running on the web conference server 70.

Thus, if a participant attempts to enter the personal meeting room of a personal meeting room owner via path 320 (without the user of a meeting key) and instead uses the normal link for a personal meeting room (https://serviceprovider.com/ownername), then the participant's entry into the personal meeting room will depend on whether the meeting room owner had entered the personal meeting room owner without a unique meeting key. As depicted at 340, the participant will be allowed entry into the personal meeting room only if the meeting room owner also entered the personal meeting room without the use of a unique meeting key. Otherwise, the participant is directed to virtual lobby or waiting room. If there are multiple meetings occurring in the personal meeting room, the web conference server 70 can direct other participants attempting to enter the meeting room with a unique meeting key that is for a different meeting (which is different from the meeting key that the meeting room owner used to enter the meeting room) into the virtual lobby or waiting room and subsequently can let them into the personal meeting room when he/she desires. Thus, when the meeting room owner enters the meeting room, only those attending the same meeting (with the same unique meeting key) will be allowed access. Those participants who have not entered the meeting room using the same unique meeting key or with a different meeting key, based on policy configured by the meeting room owner, may be automatically disconnected or allowed to stay in the personal meeting room. Based on configurations set by the meeting room, the participants may or may not lose access to the meeting room when the meeting room owner leaves the personal meeting room.

Thus, as depicted by the process 300 shown in FIG. 5, a unique URI (containing a unique meeting key) is created for a particular meeting in a personal meeting room. The meeting room owner can enter the personal meeting room for the particular meeting using the unique meeting key. Thereafter, anybody else attempting to enter the personal meeting room would have to enter using the same unique meeting key as the one used by meeting room owner. In this way, the meeting room owner can decide the level of security, if any, for a meeting. Thus, when the meeting room owner uses that unique key, then only others that join the meeting through the same unique key will be permitted to join a meeting in a personal meeting room.

The meeting room owner can configure security settings for his/her personal meeting room as follows.

1. Open for anybody. Anyone with possession of the link to the personal meeting room can enter the personal meeting room. This may require that the meeting room owner has already entered the personal meeting room and thus has unlocked it, or has configured the meeting room to let participants enter it even if the personal meeting room owner has not yet entered it.

2. Locked for anybody. Nobody can enter the personal meeting room at any time, until the personal meeting room owner changes this setting.

3. Restricted to unique meeting key. Only those participants who, after the meeting room owner has entered the meeting room with a unique meeting key, enter the meeting room using the same unique meeting key that the meeting room owner used, are allowed entry into the personal meeting room.

At any given time, the personal meeting room owner can be a person other than the actual meeting room owner, but a personal permanently or temporarily designated by the meeting room owner to be treated as if he/she were the meeting room owner, when entering the personal meeting room. Thus, in general, the meeting room owner is a “host” of a particular meeting in a personal meeting room, and the “host” may be the actual personal meeting room owner or another person designated to serve as host for a particular meeting in the personal meeting room of the meeting room owner.

These techniques allow the personal meeting room owner to choose which meeting in his/her personal meeting room to join. Thus, the personal meeting room can be transformed into a meeting resource with separately controllable meetings. By entering the personal meeting room with a particular unique meeting key, the personal meeting room owner can control which participants are allowed to enter the personal meeting room.

A software process may run on a server or on a user device of the personal meeting room owner, the software process always being connected to a personal meeting room. This software process can read the calendar of the meeting room owner, and allow the meeting room owner to choose which meeting to join and therefore which people to let into the owner's personal meeting room for a given meeting.

As an additional level of security, the aforementioned authorization engine of the web conference server 70 may have read access to the meeting room owner's calendar (identifiers of active meetings, organizer identifier and list of participants for each meeting). Alternatively, the meeting room owner (or designee) sends a list of authorized participants, either manually by entering them into a user interface, or by client software capable of reading the participant list from a calendar meeting. If participants can be authenticated (either directly or through generating pre-authenticated links on a proxy server), only those participants invited (in the participant list) to the same meeting as the meeting room owner are allowed to enter the meeting room.

Again, as shown in FIG. 5, if the meeting room owner connects to the meeting room without presenting a meeting key, the process works in the traditional personal meeting room mode, treating all the other (waiting) participants as having connected directly to the meeting room. Thus, anyone with access to the meeting room's address or name can enter the meeting room, depending on the “locked/unlocked” state of the meeting room.

In yet another enhancement, the participants who are directed into the virtual lobby or waiting room may be organized into groups based on the meeting key they used to attempt to enter the personal meeting room. The meeting room owner is given a choice to select one of the groups of participants for entry into the virtual meeting room. The groups could be described by participants, or alternatively, a service running on the web conference server may provide meeting titles based on meeting keys for the groups of participants in the virtual lobby or waiting room. Furthermore, the meeting host could store settings in which multiple (different) meeting keys are allowed into the meeting room. This would effectively allow all participants in a virtual lobby or waiting room one meeting, at the meeting room owner's discretion or configuration. Further still, the meeting room owner can spin off multiple simultaneous meetings based on the meeting key groups, and jump or switch between the meetings, potentially moving participants between them or joining two or more meetings into one meeting. A filter or list of valid meeting keys would be applied when switching between different meeting key groups.

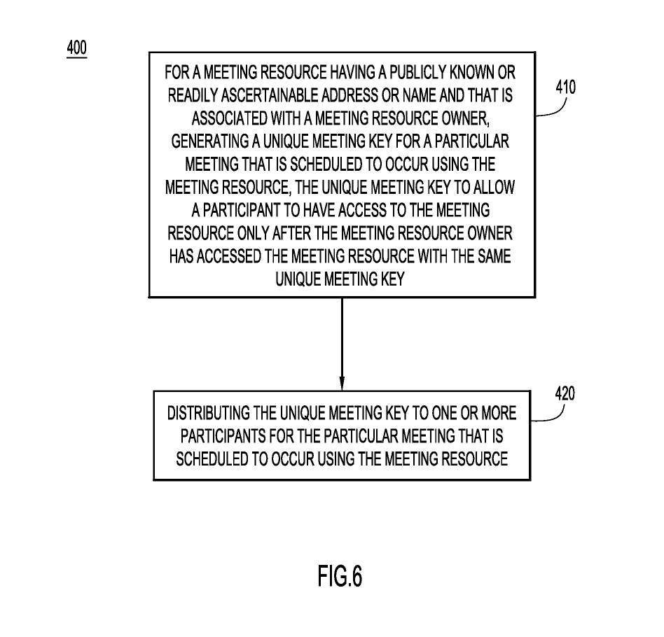

Reference is now made to FIG. 6. FIG. 6 is a flow chart depicting, at a high level, operations of a process 400 performed in accordance with example embodiments presented herein. These operations may be performed by a user device capable of scheduling a meeting or receiving an invitation for a meeting, or at a server (e.g., server 30). At 410, for a meeting resource having a publicly known or readily ascertainable address or name (or otherwise publicly accessible, such as a meeting room in a building, that is intended for personal or private use by a particular person) and that is associated with a meeting resource owner, a unique meeting key is generated for a particular meeting that is scheduled to occur using the meeting resource, the unique meeting key to allow a participant to have access to the meeting resource only after the meeting resource owner has accessed the meeting resource with the same unique meeting key. The generating step 410 may be performed for each of a plurality of different meetings so as to generating a plurality of unique meeting keys, each associated with a corresponding one of the plurality of meetings to occur using the meeting resource. At 420, the unique meeting key is distributed to one or more participants for the particular meeting that is scheduled to occur using the meeting resource. The distributing step may involve sending the unique meeting key from a user device (e.g., of or associated with the meeting resource owner or a designee thereof) to one or more participants. The unique meeting key generation may be performed on the user device (e.g., of the meeting resource owner) or on a server that is in communication with the user device.

As explained above in connection with FIGS. 1-5, in one example, the meeting resource is a physical meeting room, and the unique meeting key is a numeric or alphanumeric code to an electronic lock on a door to the physical meeting room. In addition, the unique meeting key may be generated based on a meeting calendar identifier, or may be based on a random selection of alphanumeric characters. In the case where the meeting resource is a virtual meeting room for a web-based meeting, the unique meeting key may be, or is contained, in a link to a web-based meeting hosting service for the virtual meeting room or to a proxy service for the web-based meeting hosting service. The unique meeting key may include the publicly known or readily ascertainable address or name and a unique string of characters. Furthermore, the unique meeting key may be configured to be displayed as a link containing the publicly known or readily ascertainable address or name and having associated therewith and not displayed a unique string of characters. In one form, the unique meeting key is contained in a URI of any URI scheme.

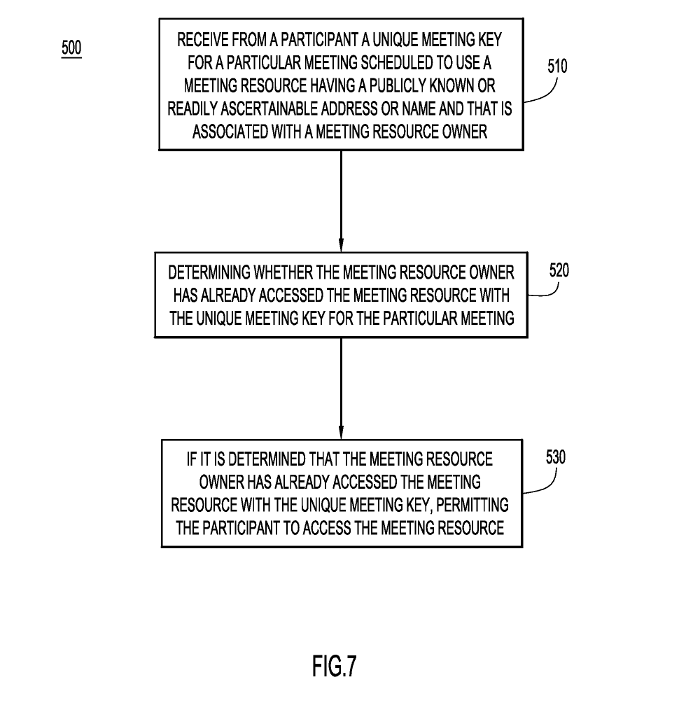

Turning now to FIG. 7, a flow chart is shown for operations of a process 500 performed by a server, e.g., server 30, in accordance with example embodiments presented herein. At 510, a unique meeting key is received from a participant for a particular meeting scheduled to use a meeting resource having a publicly known or readily ascertainable address or name (or otherwise publicly accessible, such as a meeting room in a building, that is intended for personal or private use by a particular person) and that is associated with a meeting resource owner. At 520, it is determined whether the meeting resource owner has already accessed the meeting resource with the same unique meeting key for the particular meeting. At 530, if it is determined that the meeting resource owner has already accessed the meeting resource with the same unique meeting key, the participant is permitted to access the meeting resource.

The techniques, system and devices presented above allow a meeting room owner to have multiple meetings and choose which meeting to enter and benefit from the proposed meeting lockdown mode. This is also useful for controlling access to any meeting resource, physical or virtual.

In one form, a computer-implemented method comprising: for a meeting resource having a publicly known or readily ascertainable address or name and that is associated with a meeting resource owner, generating a unique meeting key for a particular meeting that is scheduled to occur using the meeting resource, the unique meeting key to allow a participant to have access to the meeting resource only after the meeting resource owner has accessed the meeting resource with the same unique meeting key; and distributing the unique meeting key to one or more participants for the particular meeting that is scheduled to occur using the meeting resource. The distribution of the unique meeting key may involve sending the unique meeting key from a user device to one or more participants of a meeting. The generation of the unique meeting key may be performed on the user device or on a server that is in communication with the user device.

The meeting resource may be a physical meeting room, in which case the unique meeting key is a numeric or alphanumeric code to an electronic lock on a door to the physical meeting room. The unique meeting key may be based on a meeting calendar identifier and/or may be based on a random selection of characters. If the meeting resource is a virtual meeting room for a web-based meeting, the unique meeting key may be, or is contained in, a link to a web-based meeting hosting service for the virtual meeting room or to a proxy service for the web-based meeting hosting service. Moreover, the unique meeting key may include the publicly known or readily ascertainable address or name and a unique string of characters. In one example, the unique meeting key is configured to be displayed as a link containing the publicly known or readily ascertainable address or name and having associated therewith and not displayed a unique string of characters. Further, the unique meeting key may be, or is contained in, a Uniform Resource Identifier (URI) of any URI scheme. There may be multiple unique meeting keys, each associated with a different one of a plurality of meetings to occur using the meeting resource.

In another form, a computer-implemented method is provided comprising: receiving from a participant a unique meeting key for a particular meeting scheduled to use a meeting resource having a publicly known or readily ascertainable address or name and that is associated with a meeting resource owner; determining whether the meeting resource owner has already accessed the meeting resource with the same unique meeting key for the particular meeting; and if it is determined that the meeting resource owner has already accessed the meeting resource with the same unique meeting key, permitting the participant to access the meeting resource. If it is determined that the meeting resource owner has not already entered the virtual meeting room with the unique meeting key for the particular meeting, the user may be directed to a virtual lobby or waiting room. Similarly, room participants who attempt to enter the virtual meeting room using a unique meeting key that is different from the unique meeting key used by the meeting room owner may be directed to a virtual lobby or waiting room, and the participants directed to the virtual lobby or waiting room who attempt to enter the virtual meeting room with the same unique meeting key may be arranged into groups. Further still, it may be determined, based on policies configured by the meeting room owner, whether or not to permit entry into the meeting room of another user who attempts to enter the meeting room for the particular meeting with a meeting key different than the unique meeting key.

In another form, an apparatus is provided comprising: a network interface unit configured to enable network communications; and a processor coupled to the network interface unit, the processor configured to: receive, via the network interface unit, from a participant a unique meeting key for a particular meeting scheduled to use a meeting resource having a publicly known or readily ascertainable address or name and that is associated with a meeting resource owner; determine whether the meeting resource owner has already accessed the meeting resource with the same unique meeting key for the particular meeting; and if it is determined that the meeting resource owner has already accessed the meeting resource with the same unique meeting key, permit the participant to access the meeting resource.

Although the techniques are illustrated and described herein as embodied in one or more specific examples, it is nevertheless not intended to be limited to the details shown, since various modifications and structural changes may be made within the scope and range of equivalents of the claims.

What is claimed is:

1. A computer-implemented method comprising:
for a meeting resource having a publicly known or readily ascertainable address or name and that is associated with a meeting resource owner, generating a unique meeting key for a particular meeting that is scheduled to occur using the meeting resource, the unique meeting key to allow a participant to have access to the meeting resource only after the meeting resource owner has accessed the meeting resource with the same unique meeting key; and
distributing the unique meeting key to one or more participants for the particular meeting that is scheduled to occur using the meeting resource.

2. The method of claim 1, wherein the meeting resource is a physical meeting room, and the unique meeting key is a numeric or alphanumeric code to an electronic lock on a door to the physical meeting room.

3. The method of claim 1, wherein the unique meeting key is based on a meeting calendar identifier.

4. The method of claim 1, wherein the unique meeting key is based on a random selection of characters.

5. The method of claim 1, wherein the meeting resource is a virtual meeting room for a web-based meeting, and the unique meeting key is or is contained in a link to a web-based meeting hosting service for the virtual meeting room or to a proxy service for the web-based meeting hosting service.

6. The method of claim 5, wherein the unique meeting key includes the publicly known or readily ascertainable address or name and a unique string of characters.

7. The method of claim 5, wherein the unique meeting key is configured to be displayed as a link containing the publicly known or readily ascertainable address or name and having associated therewith and not displayed a unique string of characters.

8. The method of claim 5, wherein the unique meeting key is, or is contained in, a Uniform Resource Identifier (URI) of any URI scheme.

9. The method of claim 1, wherein generating comprises generating multiple unique meeting keys, each associated with a different one of a plurality of meetings to occur using the meeting resource.

10. The method of claim 1, wherein distributing comprises sending the unique meeting key from a user device to the one or more participants.

11. The method of claim 10, wherein generating is performed on the user device.

12. The method of claim 10, wherein generating is performed on a server that is in communication with the user device.

13. A computer-implemented method comprising:
receiving from a participant a unique meeting key for a particular meeting scheduled to use a meeting resource having a publicly known or readily ascertainable address or name and that is associated with a meeting resource owner;
determining whether the meeting resource owner has already accessed the meeting resource with the same unique meeting key for the particular meeting; and
if it is determined that the meeting resource owner has already accessed the meeting resource with the same unique meeting key, permitting the participant to access the meeting resource.

14. The method of claim 13, wherein the meeting resource is a virtual meeting room for a web-based meeting, and the unique meeting key is or is contained in a link to a web-based meeting hosting service for the virtual meeting room or to a proxy service for the web-based meeting hosting service.

15. The method of claim 13, wherein receiving comprises receiving the unique meeting key as part of a Uniform Resource Identifier (URI).

16. The method of claim 13, wherein if it is determined that the meeting resource owner has not already entered the virtual meeting room with the unique meeting key for the particular meeting, directing the user to a virtual lobby or waiting room.

17. The method of claim 13, further comprising directing to a virtual lobby or waiting room participants who attempt to enter the virtual meeting room using a unique meeting key that is different from the unique meeting key used by the meeting room owner, and grouping participants directed to the virtual lobby or waiting room who attempt to enter the virtual meeting room with the same unique meeting key.

18. The method of claim 18, further comprising determining, based on policies configured by the meeting room owner, whether or not to permit entry into the meeting room of another user who attempts to enter the meeting room for the particular meeting with a meeting key different than the unique meeting key.

19. An apparatus comprising:
a network interface unit configured to enable network communications;
a processor coupled to the network interface unit, the processor configured to:
receive, via the network interface unit, from a participant a unique meeting key for a particular meeting scheduled to use a meeting resource having a publicly known or readily ascertainable address or name and that is associated with a meeting resource owner;
determine whether the meeting resource owner has already accessed the meeting resource with the same unique meeting key for the particular meeting; and
if it is determined that the meeting resource owner has already accessed the meeting resource with the same unique meeting key, permit the participant to access the meeting resource.

20. The apparatus of claim 19, wherein the meeting resource is a virtual meeting room for a web-based meeting, and the unique meeting key is or is contained in a link to a web-based meeting hosting service for the virtual meeting room or to a proxy service for the web-based meeting hosting service.
